(19) United States
(12) Patent Application Publication
(10) Pub. No.: US 2025/0220595 A1
(43) Pub. Date: Jul. 3, 2025

(54) POWER CLASS DETERMINATION METHOD AND APPARATUS, AND DEVICE

(71) Applicant: Beijing Xiaomi Mobile Software Co., Ltd., Beijing (CN)

(72) Inventors: Qin MU, Beijing (CN); Juan ZHANG, Beijing (CN)

(21) Appl. No.: 18/852,359

(22) PCT Filed: Apr. 2, 2022
(86) PCT No.: PCT/CN2022/085178

§ 371 Date: Sep. 27, 2024

(51) Int. Cl. H04W 52/36; H04L 5/14; H04W 8/22

(52) U.S. Cl. CPC H04W 52/367; H04L 5/14; H04W 8/22

(57) ABSTRACT

A power class determination method includes: a terminal determines a power class corresponding to a first duplex mode, wherein the first duplex mode comprises a simultaneous transmission-reception mode and/or a non-simultaneous transmission-reception mode, and the power class represents maximum transmission power of the terminal in different duplex modes.

### CROSS-REFERENCE TO RELATED APPLICATIONS

The present application is a U.S. National Stage of International Application No. PCT/CN2022/085178, filed on Apr. 2, 2022, the contents of all of which are incorporated herein by reference in their entireties for all purposes.

### BACKGROUND OF THE INVENTION

With the development of radio communication technology, a terminal is compatible with various duplex modes including a full duplex mode (i.e. a simultaneous transmission-reception mode) and a non-full duplex mode (i.e. a non-simultaneous transmission-reception mode) in order to enhance uplink coverage.

### SUMMARY OF THE INVENTION

The disclosure provides a method and apparatus for determining a power class, and a device.

According to a first aspect of the disclosure, a method for determining a power class is provided. The method may be performed by a terminal in a communication system, and the terminal supports a plurality of duplex modes. The method includes: determining a power class corresponding to a first duplex mode by the terminal, where the first duplex mode includes a simultaneous transmission-reception mode and/or a non-simultaneous transmission-reception mode, and the power class is configured to indicate maximum transmission powers of the terminal in different duplex modes.

According to a second aspect of the disclosure, a method for configuring a power class is provided. The method may be performed by a network device in a communication system. The method includes: indicating a power class corresponding to a second duplex mode to a terminal by a network device; where the second duplex mode includes a simultaneous transmission-reception mode and/or a non-simultaneous transmission-reception mode, and the power class is configured to indicate maximum transmission powers of the terminal in different duplex modes.

According to a third aspect of the disclosure, a communication device, such as a terminal supporting a plurality of duplex modes is provided. The communication device may include a memory and a processor. The processor is connected to the memory and configured to implement the method of the first aspect and any possible embodiment by executing a computer-executable instruction stored in the memory.

According to a fourth aspect of the disclosure, a communication device, such as a network device is provided. The communication device may include a memory and a processor. The processor is connected to the memory and configured to implement the method of the second aspect and any possible embodiment by executing a computer-executable instruction stored in the memory.

According to a fifth aspect of the disclosure, a communication system is provided. The communication system may include the terminal according to the third aspect and any possible embodiment and a network device according to the fourth aspect and any possible embodiment, and the terminal communicates with the network device.

According to a sixth aspect of the disclosure, a non-transitory computer-readable storage medium is provided. The non-transitory computer-readable storage medium stores an instruction. When the instruction is run on a computer, the method of the first aspect to the second aspect and any possible embodiment is executed.

### BRIEF DESCRIPTION OF DRAWINGS

FIG. 1 is a schematic structural diagram of a communication system in an example of the disclosure;

FIG. 2 is a schematic diagram of a radio frequency (RF) structure of a terminal in an example of the disclosure;

FIG. 3 is a schematic diagram of a mapping relation between duplex modes and power classes in an example of the disclosure;

FIG. 4 is a schematic flowchart of a method for determining a power class in an example of the disclosure;

FIG. 5 is a schematic flowchart of another method for determining a power class in an example of the disclosure;

FIG. 6 is a schematic flowchart of a method for configuring a power class in an example of the disclosure;

FIG. 7 is a schematic flowchart of another method for configuring a power class in an example of the disclosure;

FIG. 8 is a schematic flowchart of yet another method for configuring a power class in an example of the disclosure;

FIG. 9 is a schematic structural diagram of a communication apparatus in an example of the disclosure;

FIG. 10 is a schematic structural diagram of a communication device in an example of the disclosure;

FIG. 11 is a schematic structural diagram of a terminal in an example of the disclosure; and

FIG. 12 is a schematic structural diagram of a network device in an example of the disclosure.

### DETAILED DESCRIPTION OF THE INVENTION

Examples will be described in detail here, and their instances are shown in the accompanying drawings. When the following description involves the accompanying drawings, the same numerals in different accompanying drawings indicate the same or similar elements unless otherwise indicated. Embodiments described in the following examples do not denote all embodiments consistent with the examples of the disclosure. On the contrary, these embodiments are merely instances of apparatuses and methods consistent with some aspects of the examples of the disclosure as detailed in the appended claims.

Terms used in the examples of the disclosure are merely used for describing specific examples rather than limiting the examples of the disclosure. Singular forms such as “a/an” and “this” used in examples of the disclosure and the appended claims are also intended to include plural forms, unless otherwise clearly stated in the context. It should also be understood that the term “and/or” used here indicates and includes any or all possible combinations of one or more of associated listed items.

It should be understood that although terms “first”, “second”, “third”, etc. may be employed in examples of the disclosure to describe all types of information, such information should not be limited to these terms. These terms are merely used for distinguishing the same type of information from each other. For example, “first information” can also be referred to as “second information” and “second information” can also be referred to as “first information” similarly without departing from the scope of examples of the disclosure. Depending on the context, the word “if” as used here can be interpreted as “at the time of” or “when” or “in response to determining”.

The disclosure relates to the technical field of radio communication, in particular to a method and apparatus for determining a power class, and a device. The example of the disclosure provides a communication apparatus. The communication system may be a communication system adopting cellular mobile communication technology. FIG. 1 is a schematic structural diagram of a communication system in an example of the disclosure. With reference to FIG. 1, the communication system 10 may include a terminal 11 and a network device 12.

In an example, the terminal 11 may be a device that provides voice or data connectivity for a user. In some examples, the terminal 11 may also be referred to as user equipment (UE), a mobile station, a subscriber unit, a station or terminal equipment (TE), etc. The terminal 11 may be a cellular phone, a personal digital assistant (PDA), a wireless modem, a handheld, a laptop computer, a cordless phone, a wireless local loop (WLL), a portable android device (pad), etc. With development of radio communication technology, devices that may access the communication system 10, communicate with a network side of the communication system 10 or communicate with other devices through the communication system 10 are all terminals in the example of the disclosure. The device may be, for example, a terminal and an automobile in intelligent transportation, a household appliance in a smart home, a power meter reading instrument or a voltage monitoring instrument in a smart grid, an environmental monitoring instrument, a video monitoring instrument in an intelligent security network, a cash register, etc. In the example of the disclosure, the terminal 11 may communicate with the network device 12, and a plurality of terminals may also communicate with one another. The terminal 11 may be statically fixed or mobile.

The network device 12 described above may be a device on an access network side for supporting a terminal to access the communication system 10. For example, the network device may be evolved NodeB (eNB) in a 4G access technology communication system, a next generation nodeB (gNB) in a 5G access technology communication system, a transmission reception point (TRP), a relay node, an access point (AP), etc.

At present, the terminal is compatible with various duplex modes including a simultaneous transmission-reception mode (for example, a full duplex mode) and a non-simultaneous transmission-reception mode (for example, a non-full duplex mode) in order to enhance uplink coverage.

Optionally, the duplex mode supported by the terminal may be a frequency division duplex (FDD), that is, uplink transmission and downlink transmission are at different frequencies respectively.

Further, when the terminal supports the simultaneous transmission-reception mode and the non-simultaneous transmission-reception mode simultaneously, the terminal may also be described to support a hybrid FDD.

If the terminal supports the simultaneous transmission-reception mode, a radio frequency (RF) structure of the terminal may include a duplexer. When the terminal works in the simultaneous transmission-reception mode, the duplexer of the terminal is enabled, and signal transmission-reception of the terminal is multiplexed by the duplexer 21.

If the terminal supports the non-simultaneous transmission-reception mode, the RF structure of the terminal may not be provided with the duplexer, and an existing RF structure may perform signal transmission-reception in a half-duplex mode, a simplex mode, etc. instead.

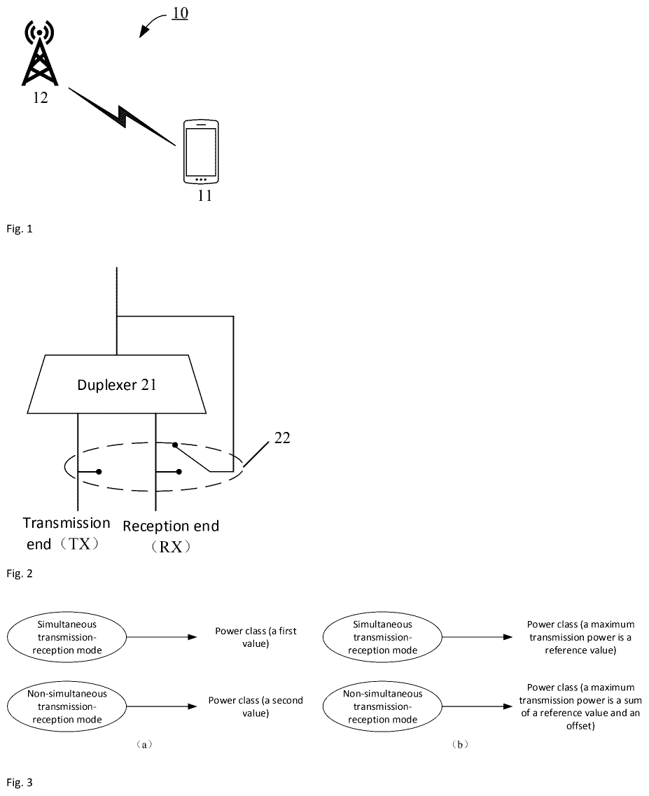

If the terminal supports the simultaneous transmission-reception mode and the non-simultaneous transmission-reception mode, the RF structure of the terminal may include the duplexer. Moreover, in order to advantageously switch the terminal to between different duplex modes, the RF structure of the terminal may adopt a structure as follows. FIG. 2 is a schematic diagram of am RF structure of a terminal in the example of the disclosure. As shown in FIG. 2, the RF structure 20 of the terminal may include a duplexer 21 and a switch 22 (which may also be described as a switcher, etc.). It is clear that when the terminal works in the simultaneous transmission-reception mode, the signal transmission and reception of the terminal are multiplexed by the duplexer 21. When the terminal works in different transmission-reception modes, the switch 22 bypasses the duplexer 21, then the duplexer 21 of the terminal is disabled, and signal transmission-reception is implemented by the existing RF structure through the half-duplex, the simplex, etc.

In an actual application, the duplexer has a loss of about 4 dB, while the switch has a smaller loss. Thus maximum transmission powers of the terminal are different when working in different duplex modes. Accordingly, it is a pressing issue to determine the maximum transmission power of the terminal.

In order to solve the above problem, the example of the disclosure provides a method for determining a power class. The method may be used to the terminal. The terminal may support the plurality of duplex modes.

At first, it should be noted that in the example of the disclosure, corresponding power classes may be defined for different duplex modes (that is, a mapping relation between the duplex modes and the power classes may be defined), to represent the maximum transmission powers in different duplex modes. That is, the power class is used to indicate the maximum transmission power of the terminal in a duplex mode.

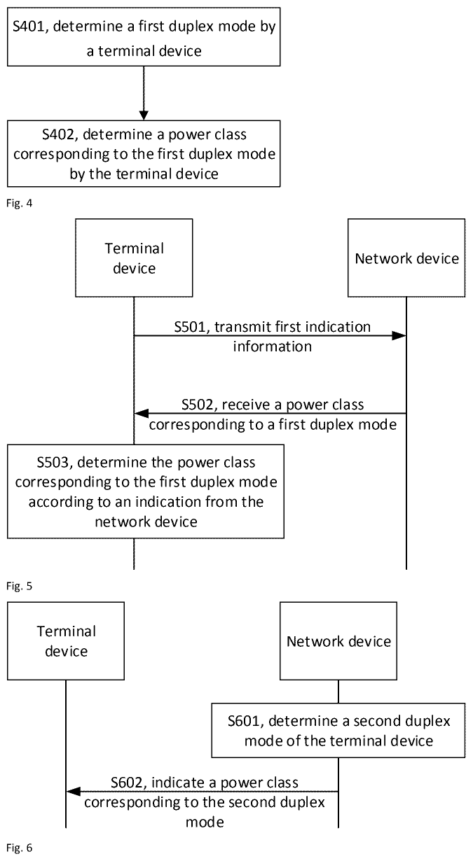

In some possible examples, FIG. 3 is a schematic diagram of a mapping relation between duplex modes and power classes in an example of the disclosure. As shown in FIG. 3(a), in response to determining that the duplex mode of the terminal is the simultaneous transmission-reception mode, it is determined that a corresponding power class is a first value. Or, in response to determining that the duplex mode is the non-simultaneous transmission-reception mode, it is determined that the power class of the terminal is a second value. The first value and the second value are unequal. Alternatively, as shown in FIG. 3(b), in response to determining that the first duplex mode is the simultaneous transmission-reception mode, it is determined that the maximum transmission power corresponding to the power class is a reference value. Or, in response to determining that the first duplex mode is the non-simultaneous transmission-reception mode, it is determined that the maximum transmission power corresponding to the power class is a sum of a reference value and an offset by the terminal.

In an example, a plurality of power classes may be defined. Illustratively, for the simultaneous transmission-reception mode, a corresponding power class may be defined as the first value (such as class x). For the non-simultaneous transmission-reception mode, a corresponding power class may be defined as the second value (such as class y). Further, when the power class is the first value, the maximum transmission power of the terminal is P1, and when the power class is the second value, the maximum transmission power of the terminal is P2. And P1 and P2 are both greater than or equal to 0, P1 is less than P2, and a difference between P1 and P2 equals at least power consumption generated by the RF structure.

In another example, a reference value (P) of the maximum transmission power and an offset (Poffset) of the maximum transmission power may be defined. Illustratively, for the simultaneous transmission-reception mode, a corresponding power class may be defined as a reference power class. For the non-simultaneous transmission-reception mode, a corresponding power class may be defined to offset from the reference power class. Further, when the power class is the reference power class, the maximum transmission power of the terminal is P (that is, the reference value), and when the power class is offset from the reference power class, the maximum transmission power of the terminal may be P+P_{offset} (that is, the sum of the reference value and the offset). And P and P_{offset} are both greater than or equal to 0, and P_{offset} may be understood as power consumption generated by the RF structure.

In the example of the disclosure, the mapping relation between duplex mode and power class may be specified by a communication protocol, or may be configured by the network device and indicated to the terminal through high-level signaling.

Illustratively, the high-level signaling described above may include radio resource control (RRC) signaling, a broadcast message, a system message, a medium access control (MAC) control element (CE), signaling carried by downlink control information (DCI) or a physical downlink shared channel (PDSCH), etc.

The method for determining a power class according to the example of the disclosure will be described below.

FIG. 4 is a schematic flowchart of a method for determining a power class in an example of the disclosure. With reference to FIG. 4, the terminal may determine the power class corresponding to the first duplex mode automatically. Then, the method described above may include:
S401, a first duplex mode is determined by a terminal.

The first duplex mode includes a simultaneous transmission-reception mode and/or a non-simultaneous transmission-reception mode.

In the example of the disclosure, the first duplex mode may be a duplex mode supported by the terminal, or a duplex mode in which the terminal works at present, or a duplex mode configured by a network device for the terminal.

For example, the terminal may determine its own supported duplex mode (that is, the first duplex mode) according to its own capability (which may be understood as its own performance, such as its own RF structure and battery life). For example, if the terminal is merely provided with a duplexer, the first duplex mode is a simultaneous transmission-reception mode. Alternatively, if the terminal is not provided with a duplexer, the first duplex mode is the non-simultaneous transmission-reception mode. Alternatively, if the terminal is provided with a duplexer and a switch, the first duplex mode is the simultaneous transmission-reception mode and the non-simultaneous transmission-reception mode.

Alternatively, if the terminal works in the simultaneous transmission-reception mode at present, the first duplex mode is the simultaneous transmission-reception mode. Alternatively, if the terminal works in the non-simultaneous transmission-reception mode, the first duplex mode is the non-simultaneous transmission-reception mode.

Alternatively, the network device may indicate to the terminal the duplex mode configured for the terminal, such as the simultaneous transmission-reception mode and/or the non-simultaneous transmission-reception mode. It may be determined that the configured duplex mode is the first duplex mode by the terminal.

It is clear that in an actual application, the first duplex mode may also be determined by the terminal according to other conditions, which is not specifically limited in the example of the disclosure.

S402, a power class corresponding to a first duplex mode is determined by a terminal.

It should be understood that after determining the first duplex mode in S401, the terminal may determine the power class corresponding to the first duplex mode according to a mapping relation between the duplex mode and the power class defined in advance or indicated by the network device.

Illustratively, in response to determining that the first duplex mode is the simultaneous transmission-reception mode, it is determined that the power class corresponding to the first duplex mode is a first value by the terminal. Or, in response to determining that the first duplex mode is the non-simultaneous transmission-reception mode, it is determined that the power class corresponding to the first duplex mode is a second value by the terminal.

Alternatively, in response to determining that the first duplex mode is the simultaneous transmission-reception mode, it is determined that a maximum transmission power corresponding to the power class corresponding to the first duplex mode is a reference value by the terminal. Or, in response to determining that the first duplex mode is the non-simultaneous transmission- reception mode, it is determined that a maximum transmission power corresponding to the power class corresponding to the first duplex mode is a sum of a reference value and an offset by the terminal.

In some possible embodiments, if it is determined that the first duplex mode is switched from the simultaneous transmission-reception mode to the non-simultaneous transmission-reception mode by the terminal on the premise that both the simultaneous transmission-reception mode and the non-simultaneous transmission-reception mode are supported by the terminal, it is determined, by the terminal, that the power class is switched from the first value to the second value or the maximum transmission power is switched from the reference value to the sum of the reference value and the offset. On the contrary, if it is determined, by the terminal, that the first duplex mode is switched from the non-simultaneous transmission-reception mode to the simultaneous transmission-reception mode, it is determined, by the terminal, that the power class is switched from the second value to the first value or the maximum transmission power is switched from the sum of the reference value and the offset to the reference value.

Illustratively, when the terminal is switched from working in the simultaneous transmission-reception mode to working in the non-simultaneous transmission-reception mode, and the duplex mode configured for the terminal by the network device is switched from the simultaneous transmission-reception mode to the non-simultaneous transmission-reception mode, or the capability of the terminal indicates that the simultaneous transmission-reception mode cannot be supported (for example, the duplexer is unavailable (which may also be described as being broken down, damaged, disabled, etc.), and the remaining power is insufficient), it is determined, by the terminal, that the first duplex mode is switched from the simultaneous transmission-reception mode to the non-simultaneous transmission-reception mode. On the contrary, when the terminal switches from working in the non-simultaneous transmission-reception mode to working in the simultaneous transmission-reception mode, and the duplex mode configured for the terminal by the network device is switched from the non-simultaneous transmission-reception mode to the simultaneous transmission-reception mode, or the capability of the terminal indicates that the simultaneous transmission-reception mode may be supported (for example, the duplexer is available (which may also be described as being recovered, enabled, etc.), and charging is completed), it is determined, by the terminal, that the first duplex mode is switched from the non-simultaneous transmission-reception mode to the simultaneous transmission-reception mode.

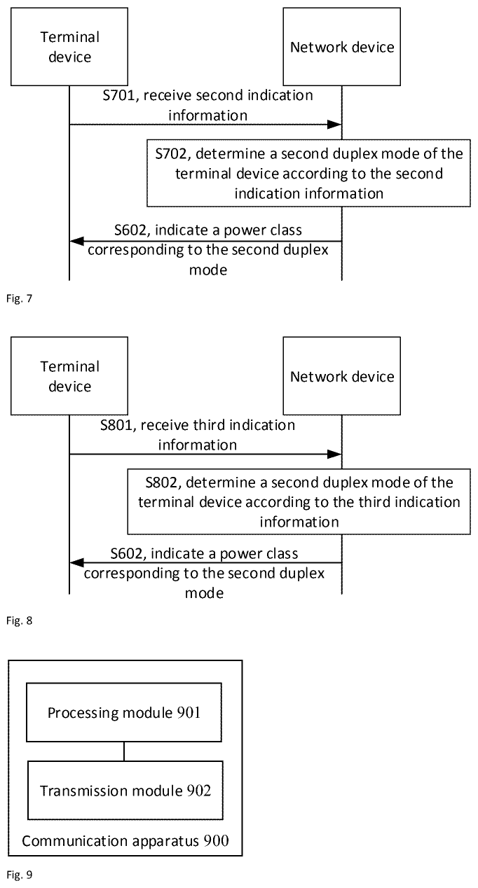

In some possible embodiments, the power class corresponding to the first duplex mode may be configured for the terminal by the network device. FIG. 5 is a schematic flowchart of another method for determining a power class in an example of the disclosure. As shown in FIG. 5, the method may further include:
S501, first indication information is transmitted to a network device by a terminal.

The first indication information may be configured to indicate a first duplex mode.

In an actual application, the first indication information may be capability information of the terminal, such as UE capability and performance information (such as the RF structure and the battery life). Alternatively, the first indication information may also be information of the duplex mode, for example, at least one bit indicates the duplex mode supported by the terminal or the duplex mode in which the terminal works at present.
S502, a power class corresponding to the first duplex mode that is indicated by the network device is received by the terminal.

It should be understood that after receiving the first indication information in S501, the network device may determine the first duplex mode of the terminal. Then the network device may determine the power class corresponding to the first duplex mode according to provisions of a communication protocol or a mapping relation that is configured for the terminal between the duplex mode and the power class. Finally, the network device indicates the power class corresponding to the first duplex mode to the terminal.
S503, the power class corresponding to the first duplex mode is determined by the terminal according to an indication from the network device.

It should be understood that the terminal may determine the power class corresponding to the first duplex mode after receiving the indication from the network device in S502.

Here, reference can be made to a detailed description in S402 in the example of FIG. 4 for an implementation process of specifically determining the power class corresponding to the first duplex mode in S503, which will not be repeated here.

In some possible examples, a value of the power class corresponding to the first duplex mode, such as the first value and/or the second value may be transmitted to the terminal by the network device. Alternatively, the maximum transmission power corresponding to the power class corresponding to the first duplex mode, such as the reference value and/or the offset, may also be transmitted to the terminal by the network device. In an actual application, the value of the power class corresponding to the first duplex mode may be indicated to the terminal by the network device through high-level signaling. Alternatively, the reference value and/or the offset of the power class corresponding to the first duplex mode may be indicated to the terminal by the network device through high-level signaling.

Accordingly, after receiving the value of the power class, the terminal may determine that the power class corresponding to the first duplex mode is the first value and/or the second value. Alternatively, after receiving the reference value that is indicated by the network device, the terminal may determine that the maximum transmission power corresponding to the power class corresponding to the first duplex mode is the reference value. Alternatively, after receiving the offset or the reference value and the offset that are indicated by the network device, the terminal may determine that the maximum transmission power corresponding to the power class corresponding to the first duplex mode is the sum of the reference value and the offset.

At this point, the process of determining the power class of the terminal is completed.

Further, after determining the power class, the terminal may apply the power class or the maximum transmission power corresponding to the power class to a process of power control, power reporting, etc.

In the disclosure, corresponding power classes are determined by the terminal according to different duplex modes, and further the corresponding maximum transmission power is further determined. Thus a subsequent process of power control, power reporting, etc. is advantageously used, and efficiency is improved.

Based on the same inventive concept, the example of the disclosure further provides a method for configuring a power class. The method may be performed by a network device in a communication system.

FIG. 6 is a schematic flowchart of a method for configuring a power class in an example of the disclosure. With reference to FIG. 6, a second duplex mode is configured for a terminal, and then a corresponding power class is configured by the network device. Here, the second duplex mode may be understood as the first duplex mode in the above example. Then, the method described above may include:
S601, the second duplex mode of the terminal is determined by the network device.

It should be understood that the second duplex mode may be determined for the terminal by the network device according to service demand, a capability (which may be understood as its own performance, such as its own RF structure and battery life) of the terminal, the duplex mode reported by the terminal, etc.

Illustratively, in a low power consumption scenario, when the capability of the terminal indicates that the terminal does not support the simultaneous transmission-reception mode, the terminal reports support of the non-simultaneous transmission-reception mode, or the terminal works in the non-simultaneous transmission-reception mode at present, the second duplex mode may be configured as the non-simultaneous transmission-reception mode by the network device. Alternatively, in a scenario with a high delay requirement, when the capability of the terminal indicates that the terminal may support the simultaneous transmission and reception mode, the terminal reports support of the simultaneous transmission-reception mode, or the terminal works in the simultaneous transmission-reception mode at present, the second duplex mode may be configured as the simultaneous transmission-reception mode by the network device. Alternatively, when the capability of the terminal indicates that the simultaneous transmission-reception mode and the non-simultaneous transmission-reception mode may be supported simultaneously, or the terminal reports support of the simultaneous transmission-reception mode and the non-simultaneous transmission-reception mode, the second duplex mode may be configured as the simultaneous transmission-reception mode and the non-simultaneous transmission-reception mode by the network device. It is clear that the second duplex mode may be further configured for the terminal by the network device according to other conditions, which is not specifically limited in the example of the disclosure.
S602, a power class corresponding to a second duplex mode is indicated to a terminal by a network device.

It should be understood that after configuring the second duplex mode in S602, the network device may determine the power class corresponding to the second duplex mode according to a mapping relation between the duplex mode and the power class defined in advance or automatically determined by the network device.

Illustratively, in response to determining that the second duplex mode is the simultaneous transmission-reception mode, it is determined that the power class corresponding to the second duplex mode is a first value by the network device. Or, in response to determining that the second duplex mode is the non-simultaneous transmission-reception mode, it is determined that the power class corresponding to the second duplex mode is a second value by the network device.

Alternatively, in response to determining that the second duplex mode is the simultaneous transmission-reception mode, it is determined that a maximum transmission power corresponding to the power class corresponding to the second duplex mode is a reference value by the network device. Or, in response to determining that the second duplex mode is the non-simultaneous transmission-reception mode, it is determined that a maximum transmission power corresponding to the power class corresponding to the second duplex mode is a sum of a reference value and an offset by the network device.

In some possible examples, a value of the power class corresponding to the second duplex mode, such as the first value and/or the second value may be transmitted to the terminal by the network device. Alternatively, a maximum transmission power corresponding to the power class corresponding to the second duplex mode, such as the reference value and/or the offset may be further transmitted to the terminal by the network device. In an actual application, the value of the power class corresponding to the second duplex mode may be indicated to the terminal by the network device through high-level signaling. Alternatively, the reference value and/or the offset of the power class corresponding to the second duplex mode may be indicated to the terminal by the network device through high-level signaling.

Accordingly, after receiving the value of the power class, the terminal may determine that the power class corresponding to the second duplex mode is the first value and/or the second value. Alternatively, after receiving the reference value that is indicated by the network device, the terminal may determine that the maximum transmission power corresponding to the power class corresponding to the second duplex mode is the reference value. Alternatively, after receiving the offset or the reference value and the offset that are indicated by the network device, the terminal may determine that the maximum transmission power corresponding to the power class corresponding to the second duplex mode is the sum of the reference value and the offset.

FIG. 7 is a schematic flowchart of another method for configuring a power class in an example of the disclosure. In some possible embodiments, as shown in FIG. 7, in response to determining that a second duplex mode is determined for a terminal by a network device according to a capability of the terminal, that is, the second duplex mode is configured for the terminal by the network device, S601 may include S701 to S702, and S602 is executed after S702.

S701, second indication information that is transmitted by the terminal is received by the network device.

Here, the second indication information may be capability information of the terminal, such as UE capability and performance information (such as an RF structure and a battery life).

S702, a second duplex mode of the terminal is determined by the network device according to the second indication information.

It should be understood that after receiving the second indication information in S601, the network device may determine the second duplex mode of the terminal according to the second indication information.

Illustratively, when the second indication information indicates that the terminal is not provided with a duplexer, the duplexer of the terminal is unavailable, and remaining power is insufficient, it is determined that the second duplex mode is a non-simultaneous transmission-reception mode by the network device. Alternatively, when the second indication information indicates that the terminal is provided with a duplexer, the duplexer of the terminal is available, and charging is completed, it is determined that the second duplex mode is a simultaneous transmission-reception mode by the network device. Alternatively, when the second indication information indicates that the terminal is provided with a duplexer and a switch, it is determined that the second duplex mode is a simultaneous transmission-reception mode and a non-simultaneous transmission-reception mode by the network device.

FIG. 8 is a schematic flowchart of another method for configuring a power class in an example of the disclosure. In some possible embodiments, as shown in FIG. 8, in response to determining that a second duplex mode of a terminal is determined according to a duplex mode that is reported by the terminal by a network device, that is, the second duplex mode of the terminal is reported to the network device by the terminal, S601 may include S801 to S802, and S602 is executed after S802.

S801, third indication information that is transmitted by the terminal is received by the network device.

Here, the third indication information may be information of the duplex mode. For example, at least one bit indicates the duplex mode supported by the terminal or the duplex mode in which the terminal works at present.

S802, a second duplex mode of the terminal is determined by the network device according to the third indication information.

It should be understood that the network device may determine that the duplex mode that is reported by the terminal is the second duplex mode after receiving the third indication information in S801.

Illustratively, when the third indication information indicates that the terminal supports the non-simultaneous transmission-reception mode or the terminal works in the non-simultaneous transmission-reception mode at present, it is determined that the second duplex mode is the non-simultaneous transmission-reception mode by the network device. Alternatively, when the third indication information indicates that the terminal supports the simultaneous transmission-reception mode or the terminal works in the simultaneous transmission-reception mode at present, it is determined that the second duplex mode is the simultaneous transmission-reception mode by the network device determines. Alternatively, when the third indication information indicates that the terminal supports the non-simultaneous transmission-reception mode and the simultaneous transmission-reception mode, it is determined that the second duplex mode is the simultaneous transmission-reception mode and the non-simultaneous transmission-reception mode by the network device.

At this point, the process of configuring the power class for the terminal by the network device is completed.

Further, after the power class is configured for the terminal by the network device, the terminal may apply the power class or the maximum transmission power corresponding to the power class to a process of power control, power reporting, etc.

In the disclosure, corresponding power classes are configured for the terminal by the network device according to different duplex modes, and then the maximum transmission powers corresponding to different duplex modes can be determined by the terminal. Thus the subsequent process of power control, power reporting, etc. is advantageously used, and efficiency is improved.

Based on the same inventive concept, the example of the disclosure provides a communication apparatus. FIG. 9 is a schematic structural diagram of a communication device in an example of the disclosure. As shown in FIG. 9, the communication device 900 may include a processing module 901 and a transmission module 902.

In some possible examples, the communication apparatus 900 may be an apparatus for determining a power class. The apparatus is a terminal supporting a plurality of duplex modes in a communication system or a chip or a system-on-chip in a terminal, and may be further a functional module in the terminal for implementing the methods described in the examples described above. The communication apparatus 900 may perform functions executed by the terminal in the examples described above, and these functions may be performed by executing corresponding software by hardware. The hardware or software includes one or more modules corresponding to the functions described above.

The processing module 901 is configured to determine a power class corresponding to a first duplex mode. The first duplex mode includes a simultaneous transmission-reception mode and/or a non-simultaneous transmission-reception mode, and the power class is configured to indicate maximum transmission powers of the terminal in different duplex modes.

In some possible embodiments, a duplexer of the terminal is enabled on a condition that the terminal works in the simultaneous transmission-reception mode. Or, a duplexer of the terminal is disabled on a condition that the terminal works in the non-simultaneous transmission-reception mode.

In some possible embodiments, the processing module 901 is configured to determine, in response to determining that the first duplex mode is the simultaneous transmission-reception mode, that the power class is a first value, or, determine, in response to determining that the first duplex mode is the non-simultaneous transmission-reception mode, that the power class is a second value by the terminal. The first value and the second value are unequal.

In some possible embodiments, the processing module 901 is configured to determine that the first duplex mode is switched from the simultaneous transmission-reception mode to the non-simultaneous transmission-reception mode, and determine that the power class is switched from the first value to the second value.

In some possible embodiments, the processing module 901 is configured to determine, in response to determining that the first duplex mode is the simultaneous transmission-reception mode, that the maximum transmission power corresponding to the power class is a reference value, or, determine, in response to determining that the first duplex mode is the non-simultaneous transmission-reception mode, that the maximum transmission power corresponding to the power class is a sum of a reference value and an offset.

In some possible embodiments, the transmission module 902 is configured to receive the reference value that is indicated by a network device, or, receive the offset that is indicated by a network device, or, receive the reference value and the offset that are indicated by a network device. The processing module 901 is configured to determine the power class corresponding to the first duplex mode according to the reference value and/or the offset.

In some possible embodiments, the transmission module 902 is configured to transmit capability information to a network device, where the capability information is configured to indicate the first duplex mode; and receive the power class corresponding to the first duplex mode that is indicated by the network device. The processing module 901 is configured to determine the power class corresponding to the first duplex mode according to an indication from the network device.

It should be noted that reference can be made to detailed descriptions of the examples in FIGS. 2 to 5 for specific implementation processes of the processing module 901 and the transmission module 902, which will not be repeated here for the sake of brevity.

In some possible embodiments, the communication apparatus 900 may be further an apparatus for configuring a power class. The apparatus is a network device in a communication system or a chip or a system-on-chip in a network device, and may be further a functional module in the network device for implementing the methods described in the examples described above. The communication apparatus 900 may perform functions executed by the network device in the examples described above, and these functions may be performed by executing corresponding software by hardware. The hardware or software includes one or more modules corresponding to the functions described above.

Then, the transmission module 902 is configured to indicate a power class corresponding to a second duplex mode to the terminal. The second duplex mode includes a simultaneous transmission-reception mode and/or a non-simultaneous transmission-reception mode, and the power class is configured to indicate maximum transmission powers of the terminal in different duplex modes.

In some possible embodiments, the processing module 901 is configured to determine the second duplex mode of the terminal before the second transmission module indicates the power class corresponding to the second duplex mode to the terminal.

In some possible embodiments, the transmission module 902 is configured to receive capability information transmitted by the terminal. The processing module 901 is configured to determine the second duplex mode of the terminal according to the capability information.

In some possible embodiments, the transmission module 902 is configured to indicate, to the terminal, that the power class is a first value in response to determining that the second duplex mode is the simultaneous transmission-reception mode, or, indicate, to the terminal, that the power class is a second value in response to determining that the second duplex mode is the non-simultaneous transmission-reception mode, where the first value and the second value are unequal.

In some possible embodiments, the transmission module 902 is configured to indicate, to the terminal, that the maximum transmission power corresponding to the power class is a reference value in response to determining that the second duplex mode is the simultaneous transmission-reception mode, or, indicate, to the terminal, that the maximum transmission power corresponding to the power class is a sum of a reference value and an offset in response to determining that the second duplex mode is the non-simultaneous transmission-reception mode.

In some possible embodiments, the transmission module 902 is configured to transmit the reference value to the terminal, or, transmit the offset to the terminal, or, transmit the reference value and the offset to the terminal.

It should be noted that reference can be made to detailed descriptions of the examples in FIG. 2 and FIGS. 6 to 8 for specific implementation processes of the processing module 901 and the transmission module 902, which will not be repeated here for the sake of brevity.

The transmission module 902 mentioned in the example of the disclosure may be a transmission-reception interface, a transmission-reception circuit, a transceiver, etc. The processing module 901 may be one or more processors.

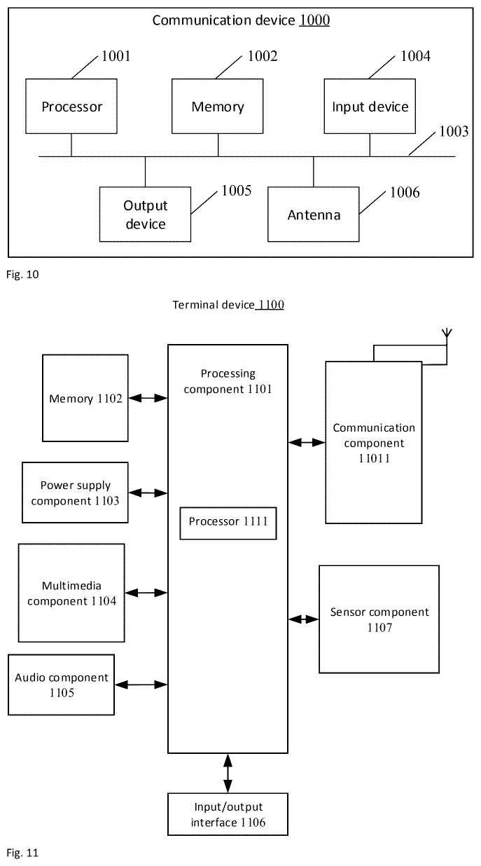

Based on the same inventive concept, the example of the disclosure provides a communication device. The communication device may be the terminal or the network device according to one or more examples described above. FIG. 10 is a schematic structural diagram of a communication device in an example of the disclosure. As shown in FIG. 10, the communication device 1000 adopts general computer hardware, including a processor 1001, a memory 1002, a bus 1003, an input device 1004 and an output device 1005.

In some possible embodiments, the memory 1002 may include a computer storage medium in the form of a volatile and/or nonvolatile memory, such as a read-only memory and/or a random access memory. The memory 1002 may store an operation system, an application, other program modules, executable codes, program data, user data, etc.

The input device 1004 may be configured to input a command and information into the communication device 1000. The input device 1004 includes a keyboard or a pointing device such as a mouse, a trackball, a touchpad, a microphone, a joystick, a game pad, a satellite television antenna, a scanner or the like. These input devices may be connected to the processor 1001 through the bus 1003.

The output device 1005 may be configured to output information by the communication device 1000. Besides the monitor, the output device 1005 may also be other peripheral output devices, such as a speaker and/or a printing device. These output devices may also be connected to the processor 1001 through the bus 1003.

The communication device 1000 may be connected to a network, for example, a local area network (LAN) through an antenna 1006. In a networked environment, a computer-executable instruction stored in the control device may be stored in a remote storage device, which is not limited to local storage.

When the processor 1001 in the communication device 1000 executes the executable code or the application stored in the memory 1002, the communication 1000 device executes the communication method on the terminal side or the network device side in the above example. Reference can be made to the example described above for a specific execution process, which is not repeated here.

In addition, the memory 1002 stores a computer-executable instruction for performing functions of the processing module 901 and the transmission module 902 in FIG. 9. The functions/implementation processes of the processing module 901 and the transmission module 902 in FIG. 9 may be implemented by invoking the computer-executable instruction stored in the memory 1002 by the processor 1001 in FIG. 10. Reference can be made to the related examples for the specific implementation processes and functions.

Based on the same inventive concept, the example of the disclosure provides a terminal. The terminal is consistent with the terminal in one or more examples described above. Optionally, the terminal may be a mobile phone, a computer, a digital broadcast terminal, a message transmission-reception device, a game console, a tablet device, a medical device, a fitness device, a personal digital assistant, etc.

FIG. 11 is a schematic structural diagram of a terminal in an example of the disclosure. With reference to FIG. 11, the terminal 1100 may include one or more of a processing component 1101, a memory 1102, a power supply component 1103, a multimedia component 1104, an audio component 1105, an input/output (I/O) interface 1106, a sensor component 1107, and a communication component 11011.

Generally, the processing component 1101 controls an overall operation of the terminal 1100, such as an operation associated with display, a telephone call, data communication, a camera operation, and a recording operation. The processing component 1101 may include one or more processors 1111 for executing an instruction, and completing all or some steps of the method described above. In addition, the processing component 1101 may include one or more modules for interaction between the processing component 1101 and other components. For example, the processing component 1101 may include a multimedia module for interaction between the multimedia component 1104 and the processing component 1101.

The memory 1102 is configured to store various types of data to support the operation through the terminal 1100. Instances of these data include instructions, contact data, phonebook data, messages, pictures, video, etc. of any application or method operated on the terminal 1100. The memory 1102 may be implemented by any type of volatile or non-volatile storage devices or their combinations, such as a static random access memory (SRAM), an electrically crasable programmable read-only memory (EEPROM), an erasable programmable read-only memory (EPROM), a programmable read-only memory (PROM), a read-only memory (ROM), a magnetic memory, a flash memory, a magnetic disk and an optical disk.

The power supply component 1103 energizes various components of the terminal 1100. The power supply component 1103 may include a power management system, one or more power supplies, and other components associated with power generation, management, and distribution for the terminal 1100.

The multimedia component 1104 includes a screen providing an output interface between the terminal 1100 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense touch, swipe, and gestures on the touch panel. The touch sensors may not merely sense a boundary of a touch or swipe action, but also measure time of duration and a pressure associated with the touch or swipe action. In some examples, the multimedia component 1104 includes a front-facing camera and/or a rear-facing camera. When the terminal 1100 is in an operational mode, for example, a photographing mode or a video mode, the front-facing camera and/or the rear-facing camera may receive external multimedia data. Each of the front-facing camera and the rear-facing camera may be a fixed-focus optical lens system or have a focal length and an optical zoom capacity.

The audio component 1105 is configured to output and/or input an audio signal. For example, the audio component 1105 includes a microphone (MIC). The microphone is configured to receive an external audio signal when the terminal 1100 is in an operational mode, such as a call mode, a recording mode or a speech identification mode. The audio signal received may be further stored in the memory 1102 or transmitted through the communication component 11011. In some examples, the audio component 1105 further includes a speaker configured to output the audio signal.

The I/O interface 1106 provides an interface between the processing component 1101 and a peripheral interface module. The peripheral interface module may be a keyboard, a click wheel, a button, etc. These buttons may include, but are not limited to: a home button, a volume button, a start button, and a lock button.

The sensor component 1107 includes one or more sensors for providing state assessments in various aspects for the terminal 1100. For example, the sensor component 1107 may detect an on/off state of the terminal 1100, and relative positioning of components. For example, the components are a display and a keypad of the terminal 1100. The sensor component 1107 may also detect position change of the terminal 1100 or a component of the terminal 1100, presence or absence of contact between the user and the terminal 1100, orientation or acceleration/deceleration of the terminal 1100, and temperature change of the terminal 1100. The sensor component 1107 may include a proximity sensor configured to detect the presence of a nearby object in the absence of any physical touch. The sensor component 1107 may further include an optical sensor, such as a complementary metal-oxide-semiconductor transistor (CMOS) or charge-coupled device (CCD) image sensor for use in an imaging application. In some examples, the sensor component 1107 may further include an acceleration sensor, a gyroscope sensor, a magnetic sensor, a pressure sensor, or a temperature sensor.

The communication component 11011 is configured to facilitate wired or wireless communication between the terminal 1100 and other devices. The terminal 1100 may access a wireless network based on a communication standard, such as WiFi, 2G or 3G, or their combinations. In an example, the communication component 11011 receives a broadcast signal or broadcast related information from an external broadcast management system via a broadcast channel. In an example, the communication component 11011 further includes a near field communication (NFC) module to promote short-range communications. For example, the NFC module may be implemented based on a radio-frequency identification (RFID) technology, an infrared data association (IrDA) technology, an ultra-wide band (UWB) technology, a Bluetooth (BT) technology, etc.

In an example, the terminal 1100 may be implemented by one or more application specific integrated circuits (ASIC), digital signal processors (DSP), digital signal processing devices (DSPD), programmable logic devices (PLD), field programmable gate arrays (FPGA), controllers, microcontrollers, microprocessors or other electronic components for executing the method.

Based on the same inventive concept, the example of the disclosure provides a network device. The network device is consistent with the network device in one or more examples described above.

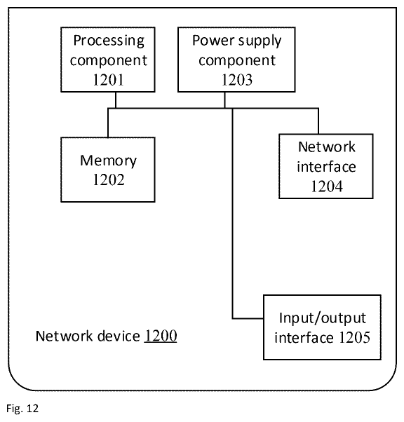

FIG. 12 is a schematic structural diagram of a network device in an example of the disclosure. With reference to FIG. 12, the network device 1200 may include a processing component 1201 and further includes one or more processors, and a memory resource represented by a memory 1202 for storing instructions, such as applications that may be executed by the processing component 1201. The applications stored in the memory 1202 may include one or more modules each corresponding to a set of instructions. In addition, the processing component 1201 is configured to execute instructions, so as to execute any method performed by the network device of the foregoing methods.

The network device 1200 may further include a power supply component 1203 configured to execute power management of the network device 1200, a wired or wireless network interface 1204 configured to network the network device 1200, and an input-output (I/O) interface 1205. The network device 1200 may operate an operation system stored in the memory 1202, such as Windows Server™, Mac OS X™, Unix™, Linux™ and FreeBSD™.

Based on the same inventive concept, the example of the disclosure further provides a computer-readable storage medium. The computer-readable storage medium stores an instruction. When the instruction is run on a computer, the method according to one or more examples described above is executed.

Based on the same inventive concept, the example of the disclosure further provides a computer program or a computer program product. The computer program product causes a computer to implement the method according to one or more examples described above when executed on the computer.

Those skilled in the art will readily conceive of other implementation solutions of the disclosure after consideration of the description and implementation of the invention disclosed here. The disclosure is intended to cover any variation, use or adaptive change of the disclosure. The variation, use or adaptive change follows general principles of the disclosure and includes common general knowledge or conventional technical means in the technical field not disclosed in the disclosure. The description and the example are merely considered illustrative, and a true scope and spirit of the disclosure are indicated by the following claims.

It should be understood that the disclosure is not limited to precise structures described above and shown in the accompanying drawings, and various modifications and changes can be made without departing from the scope of the disclosure. The scope of the disclosure is merely limited by the appended claims.

1. A method for determining a power class, comprising:
determining a power class corresponding to a first duplex mode by a terminal; wherein the first duplex mode comprises: at least one of: a simultaneous transmission-reception mode or a non-simultaneous transmission-reception mode, and the power class is configured to indicate maximum transmission powers of the terminal in different duplex modes.

2. The method according to claim 1, wherein a duplexer of the terminal is enabled on a condition that the terminal works in the simultaneous transmission-reception mode; or a duplexer of the terminal is disabled on a condition that the terminal works in the non-simultaneous transmission-reception mode.

3. The method according to claim 1, wherein the determining a power class corresponding to a first duplex mode comprises:
determining that the power class is a first value by the terminal on a condition that the first duplex mode is the simultaneous transmission-reception mode; or
determining that the power class is a second value by the terminal device on a condition that the first duplex mode is the non-simultaneous transmission-reception mode; wherein
the first value is not equal to the second value.

4. The method according to claim 3, wherein the determining a power class corresponding to a first duplex mode by a terminal comprises:
determining, by the terminal, that the first duplex mode is switched from the simultaneous transmission-reception mode to the non-simultaneous transmission-reception mode; and
determining, by the terminal-device, that the power class is switched from the first value to the second value.

5. The method according to claim 1, wherein the determining a power class corresponding to a first duplex mode by a terminal comprises:
determining that a maximum transmission power corresponding to the power class is a reference value by the terminal on a condition that the first duplex mode is the simultaneous transmission-reception mode; or determining that a maximum transmission power corresponding to the power class is a sum of a reference value and an offset by the terminal device on a condition that the first duplex mode is the non-simultaneous transmission-reception mode.

6. The method according to claim 5, wherein the determining that a maximum transmission power corresponding to the power class is a reference value by the terminal comprises: receiving the reference value that is indicated by a network device by the terminal, and determining the power class corresponding to the first duplex mode by the terminal according to the reference value.

7. The method according to claim 1, further comprising: transmitting capability information to a network device by the terminal, wherein the capability information is configured to indicate the first duplex mode; and receiving, by the terminal, the power class corresponding to the first duplex mode indicated by the network device; and
the determining a power class corresponding to a first duplex mode by a terminal comprises: determining the power class corresponding to the first duplex mode according to an indication from the network device.

8. A method for configuring a power class, comprising:
indicating, by a network device, a power class corresponding to a second duplex mode to a terminal; wherein
the second duplex mode comprises at least one of: a simultaneous transmission-reception mode or a non-simultaneous transmission-reception mode, and the power class is configured to indicate maximum transmission powers of the terminal in different duplex modes.

9. The method according to claim 8, wherein before the indicating a power class corresponding to a second duplex mode to a terminal by a network device, the method further comprises:
determining the second duplex mode of the terminal by the network device.

10. The method according to claim 9, wherein the determining the second duplex mode of the terminal by the network device comprises:
receiving, by the network device, capability information transmitted by the terminal; and
determining the second duplex mode of the terminal by the network device according to the capability information.

11. The method according to claim 8, wherein the indicating a power class corresponding to a second duplex mode to a terminal by a network device comprises:
indicating that the power class is a first value to the terminal by the network device on a condition that the second duplex mode is the simultaneous transmission-reception mode; or
indicating that the power class is a second value to the terminal by the network device on a condition that the second duplex mode is the non-simultaneous transmission-reception mode, wherein
the first value is not equal to the second value.

12. The method according to claim 8, wherein the indicating a power class corresponding to a second duplex mode to a terminal by a network device comprises:
indicating that a maximum transmission power corresponding to the power class is a reference value to the terminal by the network device on a condition that the second duplex mode is the simultaneous transmission-reception mode, or
indicating indicating that a maximum transmission power corresponding to the power class is a sum of a reference value and an offset to the terminal by the network device on a condition that the second duplex mode is the non-simultaneous transmission-reception mode.

13. The method according to claim 12, wherein the indicating that a maximum transmission power corresponding to the power class is a reference value to the terminal by the network device comprises: transmitting the reference value to the terminal by the network device.

14-26. (canceled)

27. A communication device, comprising:
an antenna;
a memory; and
one or more processors connected to the antenna and the memory, wherein the one or more processors are collectively configured to control transmission-reception by the antenna by executing a computer-executable instruction stored in the memory, and cause the communication device to:
determine a power class corresponding to a first duplex mode by a terminal; wherein
indicating the first duplex mode comprises: at least one of: a simultaneous transmission-reception mode or a non-simultaneous transmission-reception mode, and the power class is configured to indicate maximum transmission powers of the terminal in different duplex modes.

28. A communication device, comprising:
an antenna;
a memory, and
indicating one or more processors connected to the antenna and the memory, wherein the one or more processors are configured to control transmission-reception by the antenna by executing a computer-executable instruction stored in the memory, and cause the communication device to perform the method of claim 8.

29. A non-transitory computer storage medium configured to store a computer-executable instruction that, when executed by a processor, causes the processor to perform the method according to claim 1.

30. A non-transitory computer storage medium configured to store a computer-executable instruction that, when executed by a processor, causes the processor to perform the method according to claim 8.

31. The method according to claim 5, wherein the determining that the maximum transmission power corresponding to the power class is a sum of a reference value and an offset by the terminal comprises:
receiving the offset indicated by a network device by the terminal, and determining the power class corresponding to the first duplex mode by the terminal according to the offset; or
indicating receiving, by the terminal, the reference value and the offset indicated by a network device, and determining the power class corresponding to the first duplex mode by the terminal according to the reference value and the offset.

32. The method according to claim 12, wherein the indicating that the maximum transmission power corresponding to the power class is a sum of a reference value and an offset to the terminal by the network device comprises: transmitting the offset to the terminal by the network device, or transmitting the reference value and the offset to the terminal by the network device.
